(19) United States
(12) Patent Application Publication
(10) Pub. No.: US 2026/0177499 A1
(43) Pub. Date: Jun. 25, 2026

(54) ROTATING ARTICLE APPEARANCE INSPECTION APPARATUS AND ROTATING ARTICLE APPEARANCE INSPECTION METHOD

(71) Applicant: DAIICHI JITSUGYO VISWILL CO., LTD., Osaka (JP)

(72) Inventor: Koji MATSUI, Osaka (JP)

(73) Assignee: DAIICHI JITSUGYO VISWILL CO., LTD., Osaka (JP)

(21) Appl. No.: 19/425,622

(22) Filed: Dec. 18, 2025

(30) Foreign Application Priority Data
Dec. 19, 2024 (JP) 2024-224548

(51) Int. Cl. G01N 21/88; G01M 13/005

(52) U.S. Cl. CPC G01N 21/8806; G01M 13/005; G01N 2021/8841; G01N 2021/8845

(57) ABSTRACT

The O-ring appearance inspection apparatus of the present invention is an appearance inspection apparatus for inspecting an O-ring K, and includes a plurality of line sensor cameras whose positions and orientations are preset to image-capture the O-ring K, and a holding device that holds the O-ring K and has a head unit rotatable about a rotation axis C1, wherein the holding device sequentially moves the O-ring K to a plurality of image-capturing positions P respectively corresponding to the plurality of line sensor cameras, and rotates the head unit about the rotation axis C1 at each image-capturing position P to rotate the O-ring K in a circumferential direction.

### TECHNICAL FIELD

The present invention relates to an apparatus and a method for appearance inspection of rotating articles such as O-rings.

### BACKGROUND ART

Conventionally, various types of articles having shapes of rotating bodies (rotating article), such as annular, spherical, and conical forms, have been provided. Further, there is a demand for performing appearance inspection of rotating articles with high accuracy. For example, an O-ring can be cited as a rotating article formed in an annular shape. Traditionally, O-rings have been used in seal portions of various devices. In recent years, O-rings have sometimes been required to have higher airtightness, and for that purpose, O-rings (mirror-finished O-rings) having mirror-like surfaces with small surface roughness have been provided. Further, since such mirror-finished O-rings are required to have high sealing performance, even shallow dents or scratches can cause quality problems. Therefore, in recent years, there has been a demand for an appearance inspection apparatus capable of detecting extremely shallow dents, scratches, and scuffs on the surfaces of such mirror-finished O-rings.

Patent Document 1 discloses an appearance inspection apparatus capable of detecting defects such as shallow dents and scratches on the surfaces of such mirror-finished O-rings. In the appearance inspection apparatus disclosed in Patent Document 1, illumination light is emitted toward the O-ring, and the O-ring is image-captured from the same direction as the direction of the illumination light. In the appearance inspection apparatus disclosed in Patent Document 1, most of the illumination light is specularly reflected when the surface of the O-ring is normal. However, when a defective portion such as a dent or a scratch exists on the surface of the O-ring, the illumination light is diffusely reflected at the defective portion, and the light does not enter the line sensor camera. Thus, the appearance inspection apparatus of Patent Document 1 can detect defects such as shallow dents and scratches on the surfaces of mirror-finished O-rings.

### PRIOR ART DOCUMENTS

### Patent Documents

[Patent Document 1] Japanese Patent Application Laid-Open No. 2024-40819

### SUMMARY OF THE INVENTION

### Problem to be Solved

In the appearance inspection apparatus disclosed in Patent Document 1, the entire surface of an O-ring is inspected by capturing image-captures of different portions of the O-ring surface in multiple sessions. Therefore, in order to complete the appearance inspection of one O-ring, a series of operations are repeatedly performed in which the O-ring is maintained at the image-capturing position and rotated in its circumferential direction, then inclined to image-capture another portion different in the radial direction, and again rotated in the circumferential direction. Therefore, completing the appearance inspection of a single O-ring requires operations such as angular adjustment of the holding device to image-capture different portions of the O-ring and rotation of the O-ring at each angle, which results in a time-consuming process. On the other hand, there is a demand to shorten the takt time and improve the time efficiency of the inspection.

Further, in the appearance inspection of rotating articles such as O-rings, portions in the radial direction of the rotating article are image-captured over the entire circumference by rotating the rotating article in the circumferential direction in front of a line sensor camera. When rotating the rotating article, if a misalignment occurs with respect to the angle at which the orientation of the line sensor camera is set, a misalignment may result in the portion of the rotating article being image-captured, which may lead to a defective inspection. Therefore, in order to improve inspection accuracy, it is necessary to suppress misalignment of the line sensor camera when the rotating article is rotated for image-capturing.

Accordingly, an object of the present invention is to provide a rotating article appearance inspection apparatus and a rotating article appearance inspection method capable of improving inspection accuracy and shortening takt time to enhance inspection time efficiency.

### Solution to Problem

Here, the inventor of the present application first considered a configuration in which the supplied rotating article is picked up using a robot arm or similar means and image-captured in front of a line sensor camera while changing the angle of the rotating article. However, when adjusting the angle of the tip (head unit) of the robot arm to match the set angle, it is necessary to adjust multiple axes of the robot arm, resulting in a time-consuming series of operations. Further, in the appearance inspection of a rotating article, it is necessary to image-capture the surface in a plurality of portions different in the radial direction, and the adjustment of each angle is critical, making it difficult for a robot arm to maintain the accuracy of the set angles and positions.

In appearance inspection apparatus for rotating articles, it has become common practice to minimize the number of line sensor cameras and illumination devices, and under this practice, methods for performing appearance inspections have been studied. It is evident from Patent Document 1 that the conventional knowledge in this field assumes the use of a single line sensor camera for inspection. The inventors of the present application conceived a configuration in which a plurality of line sensor cameras and the like are intentionally provided, turning their idea away from such conventional knowledge. Specifically, the inventors considered a configuration in which a plurality of line sensor cameras were provided with orientations preset to image-capture multiple portions in the radial direction of the rotating article.

As a result, the inventors found that both a reduction in takt time and an improvement in inspection accuracy can be achieved by image-capturing the rotating article at each image-capturing position while quickly moving the rotating article between the line sensor cameras. The reduction in takt time and the improvement in inspection accuracy have traditionally been recognized as conflicting requirements, and achieving both has been a technical challenge that had long been desired to be solved but had not been successfully achieved. By overcoming the conventional technical prejudice that it is common practice to perform appearance inspection with the minimum number of devices such as line sensor cameras, the inventors of the present application broke through the conflicting relationship between shortening of takt time and improvement of inspection accuracy, solved the technical challenge that had long been desired to be solved, and completed the present invention.

(1) Based on the above findings, the rotating article appearance inspection apparatus of the present invention is an appearance inspection apparatus for inspecting a rotating article having the shape of a rotating body, and includes a plurality of line sensor cameras of which the positions and orientations are preset and image-capture the rotating article, and a holding device that holds the rotating article and has a head unit rotatable about its rotation axis, wherein the holding device sequentially moves the rotating article to a plurality of image-capturing positions respectively corresponding to the plurality of line sensor cameras, and rotates the head unit about its rotation axis at each image-capturing position to rotate the rotating article in its circumferential direction.

In the rotating article appearance inspection apparatus of (1), by moving the rotating article between a plurality of image-capturing positions respectively corresponding to a plurality of line sensor cameras whose positions and orientations are preset, it becomes unnecessary to adjust the angle of the rotating article at each image-capturing position. Therefore, in the rotating article appearance inspection apparatus of the present invention, it is possible not only to suppress the occurrence of angular misalignment during angular adjustment of the rotating article but also to shorten the takt time required for the angular adjustment of the rotating article. Further, in the rotating article appearance inspection apparatus of (1), by rotating the rotating article and capturing images with the line sensor cameras, it is possible to image-capture the entire circumference of a portion in the radial direction of the rotating article. Therefore, in the rotating article appearance inspection apparatus of the present invention, it is possible to detect scratches and the like with higher accuracy as compared with the case of image-capturing by an area camera. As a result, the rotating article appearance inspection apparatus of the present invention can improve inspection accuracy and shorten the takt time, thereby enhancing the time efficiency of inspection.

(2) The rotating article appearance inspection apparatus of the present invention may be the rotating article appearance inspection apparatus described in (1) above, wherein the holding device sequentially moves the rotating article to a plurality of the image-capturing positions while maintaining its posture, and rotates the head unit about its rotation axis with the posture maintained at each of the image-capturing positions to rotate the rotating article in its circumferential direction.

In the rotating article appearance inspection apparatus of (2), by moving the rotating article between a plurality of image-capturing positions and rotating the same in the circumferential direction at each image-capturing position while maintaining its posture, it becomes unnecessary to adjust the angle of the head unit at each image-capturing position. Therefore, in the rotating article appearance inspection apparatus of (2), it is possible not only to suppress the occurrence of angular misalignment during angular adjustment of the head unit but also to shorten the takt time required for the angular adjustment of the head unit. As a result, the rotating article appearance inspection apparatus of (2) can improve inspection accuracy and shorten the takt time, thereby enhancing the time efficiency of inspection.

(3) The rotating article appearance inspection apparatus of the present invention may be the rotating article appearance inspection apparatus of (1) or (2), wherein the line sensor cameras are pre-focused on the image-capturing positions, and the holding device moves the rotating article to the image-capturing positions where the line sensor cameras are in focus, and rotates the head unit about its rotation axis at the image-capturing positions to rotate the rotating article in a circumferential direction.

In the rotating article appearance inspection apparatus of (3), the focus of the line sensor cameras is fixed in advance, and the holding device moves the rotating article to that position. Therefore, in the rotating article appearance inspection apparatus of (3), it is not necessary to adjust the focus of the line sensor camera each time according to the size of the rotating article. As a result, the rotating article appearance inspection apparatus of (3) can improve inspection accuracy and shorten the takt time, thereby further enhancing the time efficiency of inspection.

(4) The rotating article appearance inspection apparatus of the present invention may be the rotating article appearance inspection apparatus according to any one of (1) to (3) above, wherein the holding device is a robot having fewer than six axes.

In the rotating article appearance inspection apparatus of (4), compared with a six-axis configuration (for example, a robot arm), the complexity of the mechanism and control can be reduced, thereby enabling quick movement between the plurality of image-capturing positions while ensuring positioning accuracy.

(5) The rotating article appearance inspection apparatus of the present invention may be the rotating article appearance inspection apparatus of (4) above, wherein the plurality of image-capturing positions are arranged along one plane or one line, and the holding device may be a multi-joint robot having three or four axes, including one or two axes for moving the head unit on the plane or the line, one axis for moving the head unit in a direction intersecting the plane or the line, and one axis for rotating the head unit.

In the rotating article appearance inspection apparatus of (5), it is possible to reduce the number of axes of the holding device by adopting a method in which the rotating article is sequentially moved to a plurality of image-capturing positions respectively corresponding to a plurality of line sensor cameras whose positions and orientations are preset. In other words, in the rotating article appearance inspection apparatus of (5), the head unit can be positioned with high accuracy by reducing the degree of freedom in which the head unit can move. Thus, in the rotating article appearance inspection apparatus of (5), the complexity of the mechanism and control of the holding device can be reduced, thereby enabling quick movement between the plurality of image-capturing positions while ensuring positioning accuracy. That is, in the rotating article appearance inspection apparatus of (5), by configuring the holding device to have four or fewer axes, both improvement in the accuracy of the appearance inspection and shortening of the takt time can be achieved.

(6) The rotating article appearance inspection apparatus of the present invention may be the rotating article appearance inspection apparatus according to any one of (1) to (4) above, wherein the plurality of line sensor cameras are arranged such that their positions and orientations are set so that a portion in the radial direction of the rotating article, which rotates in its circumferential direction at each image-capturing position, and are configured such that the image-captured results of the plurality of the line sensor cameras include the entire area on one half toroidal portion of the rotating article. The holding device aligns the central axis of the rotating article with the rotation axis of the head unit and, while maintaining the posture of the rotating article, sequentially moves the rotating article to a plurality of image-capturing positions respectively corresponding to a plurality of line sensor cameras of which the positions and orientations are maintained. By rotation of the head unit about its rotation axis at each imaging position, the rotating article, while rotating in its circumferential direction, is image-captured by the line sensor cameras.

In the rotating article appearance inspection apparatus of (6), image-capturing is performed at each image-capturing position with the rotation axis of the head unit aligned with the central axis of the rotating article and with the posture of the rotating article maintained. Further, in the rotating article appearance inspection apparatus of (6), the plurality of line sensor cameras are set in positions and orientations such that they image-capture a portion in the radial direction of the rotating article throughout the entire circumference, and such that the image-capturing results of the plurality of line sensor cameras cover one half toroidal portion of the rotating article. Thus, the rotating article appearance inspection apparatus of (6) can image-capture one half toroidal portion of the rotating article without omission while suppressing relative angular misalignment between the rotation axis of the head unit and the orientations of the line sensor cameras, thereby improving the accuracy of the appearance inspection. As a result, the rotating article appearance inspection apparatus of (6) can improve inspection accuracy and shorten the takt time, thereby enhancing the time efficiency of inspection.

(7) The rotating article appearance inspection apparatus of the present invention may be the rotating article appearance inspection apparatus according to any one of (1) to (6), wherein the holding device is configured such that, in at least part of the operations including a movement operation of the rotating article between the image-capturing positions and a rotation operation of the head unit, the head unit is oriented obliquely downward or downward.

According to the rotating article appearance inspection apparatus of (7), it is unnecessary to orient the head unit upward during the movement operation between the image-capturing positions and the rotation operation at each image-capturing position after picking up the rotating article, and furthermore, the takt time required to adjust the angle of the head unit can be shortened. As a result, the rotating article appearance inspection apparatus of (7) can improve inspection accuracy and further enhancing the time efficiency of inspection.

(8) The rotating article appearance inspection apparatus of the present invention may be the rotating article appearance inspection apparatus according to any one of (1) to (7), wherein one or more illumination devices are provided for the plurality of line sensor cameras for emitting light toward the rotating article at the image-capturing positions. Each of the illumination device has one or more illumination units, and at least one of the illumination units may be a first illumination unit configured to emit at least a part of light toward the rotating article at the image-capturing position along the orientation of the line sensor camera associated with the illumination device.

In the rotating article appearance inspection apparatus of (8), at least part of the light from the first illumination unit enters the line sensor camera along its optical axis. Thus, the rotating article appearance inspection apparatus of (8) can detect slight variation such as surface scuffs and shallow scratches that cannot be detected by normal illumination (for example, diffused light). As a result, the rotating article appearance inspection apparatus of (8) can further improve inspection accuracy and shorten the takt time, thereby enhancing the time efficiency of inspection.

(9) The rotating article appearance inspection apparatus of the present invention may be the rotating article appearance inspection apparatus according to any one of (1) to (8), wherein one or more of the illumination devices provided corresponding to the plurality of line sensor cameras include the first illumination unit that emits any one of green light, red light, and blue light, and a second illumination unit that emits light of a color different from that of the first illumination unit, and the first illumination unit may be positioned at a greater distance from the image-capturing position than the second illumination unit.

In the rotating article appearance inspection apparatus of (9), the first illumination unit is arranged farther from the image-capturing position than the second illumination unit. Therefore, the first illumination unit reflects light having a higher degree of parallelism than that of the second illumination unit from the rotating article and causes it to enter the line sensor camera. Further, a mirror-finished rotating article has the property that light is specularly reflected. Therefore, in the rotating article appearance inspection apparatus of (9), at least part of the light from the first illumination unit enters the line sensor camera so as to be specularly reflected. Thus, surface scuffs and shallow scratches that cannot be detected by the light from the second illumination unit can be detected. Further, in the rotating article appearance inspection apparatus of (9), in addition to the first illumination unit, a second illumination unit is provided at a position closer to the image-capturing position. Thus, the rotating article appearance inspection apparatus of (9) can simultaneously detect both ordinary scratches and slight variation such as surface scuffs and shallow scratches that cannot be detected by the light from the second illumination unit. As a result, the rotating article appearance inspection apparatus of (9) can further improve inspection accuracy and shorten the takt time, thereby enhancing the time efficiency of inspection.

(10) The rotating article appearance inspection apparatus of the present invention may be the rotating article appearance inspection apparatus according to any one of (1) to (9), wherein the rotating article may be an O-ring.

According to the rotating article appearance inspection apparatus of (10), the inspection accuracy of the O-ring can be improved and the takt time can be shortened, thereby enhancing the time efficiency of inspection.

(11) The rotating article appearance inspection method of the present invention is a rotating article appearance inspection method using a rotating article appearance inspection apparatus including line sensor cameras for image-capturing a rotating article having the shape of a rotating body and a holding device for holding the rotating article, wherein positions and orientations of a plurality of the line sensor cameras are preset, and the rotating article is sequentially moved (moving step) to a plurality of image-capturing positions respectively corresponding to the plurality of line sensor cameras.

In the rotating article appearance inspection method of (11), by moving the rotating article between a plurality of image-capturing positions respectively corresponding to a plurality of line sensor cameras whose positions and orientations are preset, it becomes unnecessary to adjust the angle of the rotating article at each image-capturing position. Therefore, in the rotating article appearance inspection method of (11), it is possible not only to suppress the occurrence of angular misalignment during angular adjustment of the rotating article but also to shorten the takt time required for the angular adjustment of the rotating article. As a result, the rotating article appearance inspection method of (11) can improve inspection accuracy and shorten the takt time, thereby enhancing the time efficiency of inspection.

### Advantageous Effect of the Invention

According to the present invention, it is possible to provide a rotating article appearance inspection apparatus and a rotating article appearance inspection method that can improve inspection accuracy and shorten the takt time to enhance the time efficiency of inspection.

### BRIEF DESCRIPTION OF THE DRAWINGS

FIG. 1 is a schematic diagram showing an entire O-ring appearance inspection apparatus according to an embodiment of the present invention.

FIG. 2 is a diagram showing an example of an O-ring that is an inspection target of the O-ring appearance inspection apparatus of FIG. 1. (a) is a plan view, (b) is a cross-sectional view taken along the A1-A1 section line in FIG. 2(a), and (c) is a cross-sectional view showing a state in which the O-ring is in tight contact with a tack surface body.

FIG. 3 is an exploded perspective view showing a head unit of the O-ring appearance inspection apparatus of FIG. 1.

FIG. 4 is a diagram showing the positions of the line sensor cameras and the illumination devices of the O-ring appearance inspection apparatus of FIG. 1. (a) is a front view, (b) is a plan view, (c) is a partial enlarged view showing a first illumination light in a plan view, and (d) is a partial enlarged view showing a first illumination light in a front view.

FIG. 5 is a front view showing the angles of the optical axes of the respective line sensor cameras of the O-ring appearance inspection apparatus of FIG. 1.

FIG. 6 is a diagram showing the operation of the O-ring appearance inspection apparatus of FIG. 1.

FIG. 7 is a perspective view showing the camera optical axis, illumination light, and an inspection target portion of the O-ring appearance inspection apparatus of FIG. 1.

FIG. 8 is a diagram showing the angles of optical axes, inspection target portions, and images as image-capturing results at respective image-capturing positions of the O-ring appearance inspection apparatus of FIG. 1.

### DESCRIPTION OF EMBODIMENTS

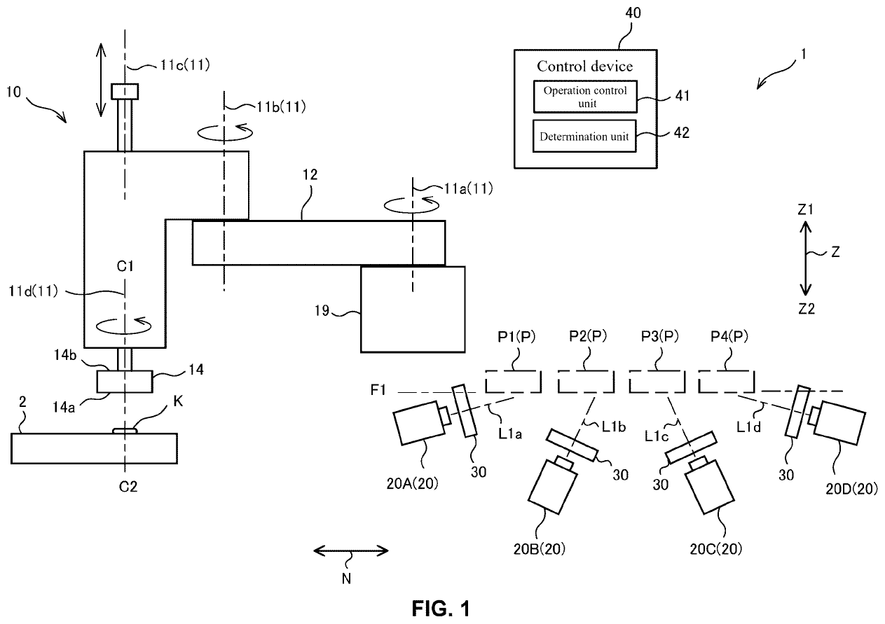

Embodiments of the present invention will be described below with reference to the drawings. FIG. 1 is a schematic diagram showing an entire O-ring appearance inspection apparatus 1 (rotating article appearance inspection apparatus) according to an embodiment of the present invention.

A “rotating article” is an article having the shape of a rotating body. A rotating body is a three-dimensional shape formed by, for example, rotating a planar shape about a straight line (central axis). Examples of the rotating body include a sphere, a circular cylinder, a circular cone, a donut shape (annular), a coin shape, and the like. Examples of the rotating articles include an annular article having an annular appearance, a spherical article having a spherical appearance, and the like. Examples of the annular article include an O-ring. Examples of the spherical articles include spheres used in ball bearings.

The O-ring appearance inspection apparatus 1 is configured to perform an appearance inspection of an O-ring K. Specifically, the O-ring appearance inspection apparatus 1 is used for inspecting scratches, deformation, and the presence or absence of foreign matter adhering to the surface of the O-ring K (appearance inspection). The rotating article appearance inspection of the present invention is not limited to the appearance inspection of the O-ring K, and is applicable to the appearance inspection of various rotating articles.

The O-ring K is, for example, a component for sealing a fluid such as a gas or a liquid. The O-ring K is used in a variety of fields, including automobiles, hydraulic and pneumatic equipment, household electrical appliances, and semiconductor equipment. The O-ring K includes, for example, those having a mirror-like glossy finish with small surface roughness. The O-ring appearance inspection apparatus of the present invention can particularly suitably perform appearance inspection on an O-ring having a mirror-finished surface. In this specification, an O-ring with a mirror-finished surface may simply be referred to as a “mirror-finished O-ring”. The mirror-finished O-ring may have an arithmetic mean roughness (Ra) of 0.2 μm or less and a maximum height roughness (Rz) of 1.0 μm or less, for example, in surface roughness measurement conducted according to JIS B 0601:2013. The O-ring may have Ra of 0.1 μm or less and Rz of 0.5 μm or less. However, the measurement conditions shall be a cut-off value λc of 0.8 mm and an evaluation length of 5λc.

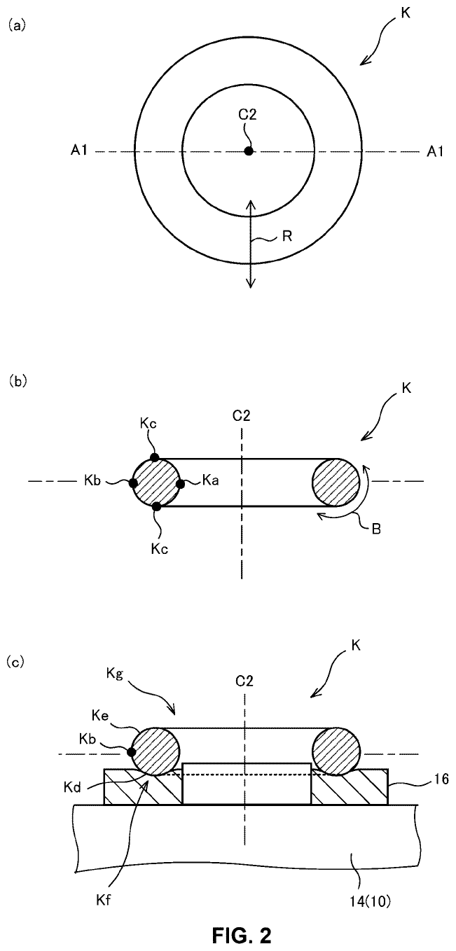

As shown in FIG. 2(a), the O-ring K has an annular appearance in a plan view. Also, as shown in FIG. 2(b), the O-ring K has a cross-sectional shape such as a circular (including a true circle) or an elliptical shape. Further, the cross-sectional shape of the O-ring K is not particularly limited, and examples include a rectangular shape, an X-shape, a D-shape (semi-circular shape), a V-shape, an H-shape, a U-shape, a T-shape, an L-shape, and the like. That is, a curved surface is formed on the surface of the O-ring K.

In the present specification, a line passing through the center in a plan view of the O-ring K is referred to as a “central axis C2”. The central axis C2 can be regarded as a centerline when the O-ring K is rotated in the circumferential direction. In the present specification, the radial direction of the O-ring K is simply referred to as “radial direction R”. In the present specification, an end portion in the central axis C2 direction of the O-ring K is referred to as “top Kc”, an inner end in the radial direction R is referred to as “inner end Ka”, and an outer end in the radial direction R is referred to as “outer end Kb”. In the present specification, the circumferential direction of the cross section of the O-ring K is referred to as “cross-sectional circumferential direction B” in a cross-sectional view when the O-ring K is cut along a section including the central axis C2 (the A1-A1 section in FIG. 2(a)).

As will be described later, the O-ring K is held by a holding device 10 in tight contact with a tack surface body 16 (see FIG. 2(c)). In the present specification, in a state where the O-ring K is in tight contact with the tack surface body 16, a portion of the O-ring K that is in contact with the tack surface body 16 may be referred to as “contact portion Kd”. Further, in the present specification, in a state where the O-ring K is in tight contact with the tack surface body 16, a portion of the O-ring K that is not in contact with the tack surface body 16 (a portion other than the contact portion Kd) may be referred to as “exposed portion Ke”.

In the present specification, one portion of the entire O-ring K obtained when the O-ring K is divided by a virtual plane including the outer end Kb is referred to as “one half toroidal portion”. One side can be regarded as one of the two sides of the O-ring K in the direction of the central axis C2. In the present specification, the two sides of the O-ring K in the direction of the central axis C2 are simply referred to as “both sides of the O-ring”.

In the present specification, one half toroidal portion of the O-ring K including a portion (contact portion Kd) that is in contact with the tack surface body 16 may be simply referred to as “contact side Kf”. Also, in the present specification, the other side of the O-ring K, which is different from the one half toroidal portion (contact side Kf) including the portion (contact portion Kd) that is in contact with the tack surface body 16, may be simply referred to as “exposed side Kg”.

In the following description, the up-down direction in the state where the O-ring appearance inspection apparatus 1 is installed is simply referred to as “up-down direction Z”. In the up-down direction Z, the upward direction is simply referred to as “upward Z1” and the downward direction is simply referred to as “downward Z2”.

In the following description, a direction orthogonal to the up-down direction Z (horizontal direction) is referred to as “lateral direction N”. The lateral direction N can be regarded as a horizontal direction orthogonal to the up-down direction Z when the O-ring appearance inspection apparatus 1 is installed, including the front-rear direction and the left-right direction of the O-ring appearance inspection apparatus 1.

As shown in FIG. 1, the O-ring appearance inspection apparatus 1 includes a holding device 10, a plurality of line sensor cameras 20, a plurality of illumination devices 30, and a control device 40.

As described above, the O-ring appearance inspection apparatus 1 includes a plurality of line sensor cameras 20. The O-ring appearance inspection apparatus 1 is configured to include a plurality of image-capturing positions P corresponding to the respective line sensor cameras 20. The O-ring appearance inspection apparatus 1 moves between the respective image-capturing positions P while holding the O-ring K by the holding device 10, and image-captures the O-ring K at each image-capturing position P. Note that in the O-ring appearance inspection apparatus 1 of the present embodiment, four times of image-capturing are performed on one half toroidal portion of the O-ring K.

### [Holding Device]

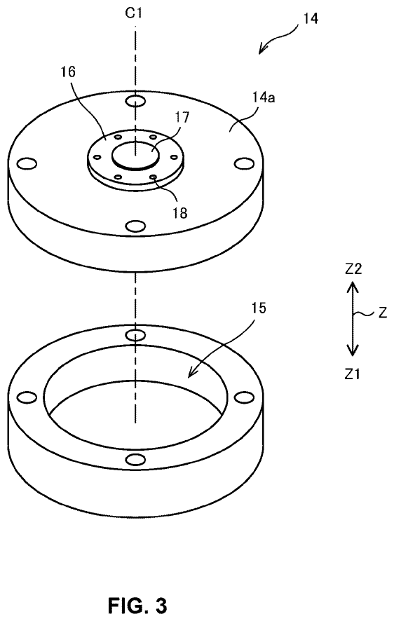

The holding device 10 holds the O-ring K. As shown in FIG. 1, the holding device 10 includes a base unit 19, an arm unit 12, and a head unit 14. Also, as shown in FIG. 3, the head unit 14 of the holding device 10 has a tack surface body 16 and a positioning member 17.

The present embodiment illustrates an example in which a horizontal multi-joint robot (so-called SCARA (Selective Compliance Assembly Robot Arm)) is employed as the holding device 10, which includes a base unit 19 and an arm unit 12, and the arm unit 12 moves so as to pivot relative to the base unit 19. The holding device 10 operates such that the arm unit 12 pivots along the lateral direction N relative to the base unit 19, and moves the O-ring K between a plurality of image-capturing positions P formed along one plane (first virtual plane FIG. 1).

More specifically, the holding device 10 of the present embodiment is a four-axis multi-joint robot having four axes 11. In the rotating body appearance inspection apparatus of the present invention, the axes include those that move the head unit along a rotational trajectory, those that rotate the head unit (rotation axes), and those that move the head unit along a linear trajectory (linear axes).

Specifically, in the present embodiment, the holding device 10 is an multi-joint robot having four axes 11, including: two axes 11a and 11b (two rotation axes) that move the head unit 14 along a circular trajectory on one plane (first virtual plane F1); one axis 11c (one linear axis) that moves the head unit 14 along a linear trajectory in a direction intersecting the first virtual plane F1 (up-down direction Z); and one axis 11d (one rotation axis) that rotates the head unit 14.

Although the present embodiment illustrates an example in which a horizontal multi-joint robot is employed as the holding device, the holding device is not limited to this. The holding device can variously adopt, for example, a moving device (such as a robot) that can hold and move the rotating article.

For example, the holding device may employ one or two axes for movement between image-capturing positions (movement operation between image-capturing positions). For example, the holding device may include a single linear axis for the movement operation between image-capturing positions. For example, the holding device may include a single rotation axis for the movement operation between image-capturing positions. For example, the holding device may include two axes (axis configuration: rotation axis-rotation axis) that move the head unit along a circular trajectory for the movement operation between image-capturing positions. For example, the holding device may include two axes, a single rotation axis and a single linear axis (axis configuration: rotation axis-linear axis), for the movement operation between image-capturing positions.

Further, the holding device may employ one having a single axis for movement between a mounting surface (mounting part) and one plane (pickup/release operation). For example, the holding device may include a single linear axis for the pickup/release operation. For example, the holding device may include a single rotation axis for the pickup/release operation. It should be noted that when a rotating body member is placed on the mounting part, the holding device preferably has a single linear axis that moves the head unit in the up-down direction for the pickup/release operation.

Further, the holding device may employ one having a single axis for rotation of the head unit (head unit rotation operation) at the image-capturing position. For example, the holding device may employ one having a single rotation axis for the head unit rotation operation.

Note that the movement operation between image-capturing positions is not limited to movement on the first virtual plane F1 (X-Y plane) and may be movement on a plane in the up-down direction Z (Z-X plane or Z-Y plane). The pickup/release operation is not limited to a linear movement in the up-down direction Z and may be a linear movement or rotation in the lateral direction N (X direction or Y direction).

The holding device may be a robot having fewer than six axes. Thus, compared with a six-axis configuration (for example, a robot arm), the complexity of the mechanism and control can be reduced, thereby enabling quick movement between the plurality of image-capturing positions while ensuring positioning accuracy.

For example, the holding device may employ one having four or fewer axes. That is, the holding device may employ any one of the axis configurations having one to four axes. In the rotating article appearance inspection apparatus of the present invention, the number of axes of the holding device can be reduced by adopting a method in which the rotating article is sequentially moved to a plurality of image-capturing positions respectively corresponding to a plurality of line sensor cameras whose positions and orientations are preset. In other words, in the rotating article appearance inspection apparatus of the present invention, the head unit can be positioned with high accuracy by reducing the degree of freedom in which the head unit can move. Thus, the complexity of the mechanism and control of the holding device can be reduced, thereby enabling quick movement between the plurality of image-capturing positions while ensuring positioning accuracy. That is, by configuring the holding device to have four or fewer axes, both improvement in the accuracy of the appearance inspection and shortening of the takt time can be achieved.

The holding device is not particularly limited, and examples include, in addition to a horizontal multi-joint robot (SCARA robot), a Cartesian coordinate robot having three linear axes (axis configuration: linear axis-linear axis-linear axis), a cylindrical coordinate robot having three axes including one rotation axis and two linear axes (axis configuration: linear axis-linear axis-rotation axis), a polar coordinate robot having three axes including two rotation axes and one linear axis (axis configuration: rotation axis-rotation axis-linear axis), and a parallel link robot.

It should be noted that the rotation axis may employ, for example, a motor. The linear axis may be configured with a motor (for example, a servo motor) and a ball screw, or may be configured with a linear motor.

The head unit 14 is rotatable about a rotation axis C1. As shown in FIG. 3, the head unit 14 has a cylindrical appearance, and its interior is hollow. A not-shown negative pressure generator is connected to the head unit 14. This allows the head unit 14 to make its interior (negative pressure chamber 15) a negative pressure or a positive pressure. In other words, the holding device 10 has a negative pressure chamber 15 that generates a negative pressure.

In the present specification, regarding the orientation of the head unit 14, a state in which the distal end surface 14a faces down in the Z2 direction is referred to as “downward,” a state in which the distal end surface 14a is inclined with respect to the lateral direction N is referred to as “oblique,” and a state in which the distal end surface 14a is inclined with respect to the lateral direction N and is positioned lower in the Z2 direction than the other surface (proximal end surface 14b) of the head unit 14 is referred to as “obliquely downward”.

As shown in FIG. 3, the tack surface body 16 and the positioning member 17 are provided on the distal end surface 14a of the head unit 14. The positioning member 17 is configured such that, when the O-ring K is held on the tack surface body 16, the outer peripheral surface thereof comes into contact with at least a portion of the inner peripheral surface of the O-ring K. It should be noted that in the holding device 10 of the present embodiment, the distal end surface 14a faces down in the up-down direction Z.

The tack surface body 16 holds the O-ring K while keeping it in tight contact. The tack surface body 16 has physical tackiness. Specifically, the tack surface body 16 is made of a material that has physical tackiness resulting from its flexibility. The tack surface body 16 enhances its tight contact with the O-ring K through elastic deformation and is capable of holding the O-ring K in tight contact. That is, the tack surface body 16 is made of a material that can temporarily fix an object by keeping it in tight contact without using an adhesive.

As shown in FIG. 3, the tack surface body 16 has a through hole (suction port 18) that communicates with the negative pressure chamber 15. The holding device 10 can generate a negative pressure at the suction port 18 while the O-ring K is in tight contact with the tack surface body 16 and positioned by the positioning member 17. Thus, the O-ring K is held on the distal end surface 14a of the head unit 14 by the tackiness of the tack surface body 16 and the suction force generated at the suction port 18. Further, the holding device 10 can remove the O-ring K that is in tight contact with the tack surface body 16 by discharging air from the negative pressure chamber 15 through the communication hole (suction port 18).

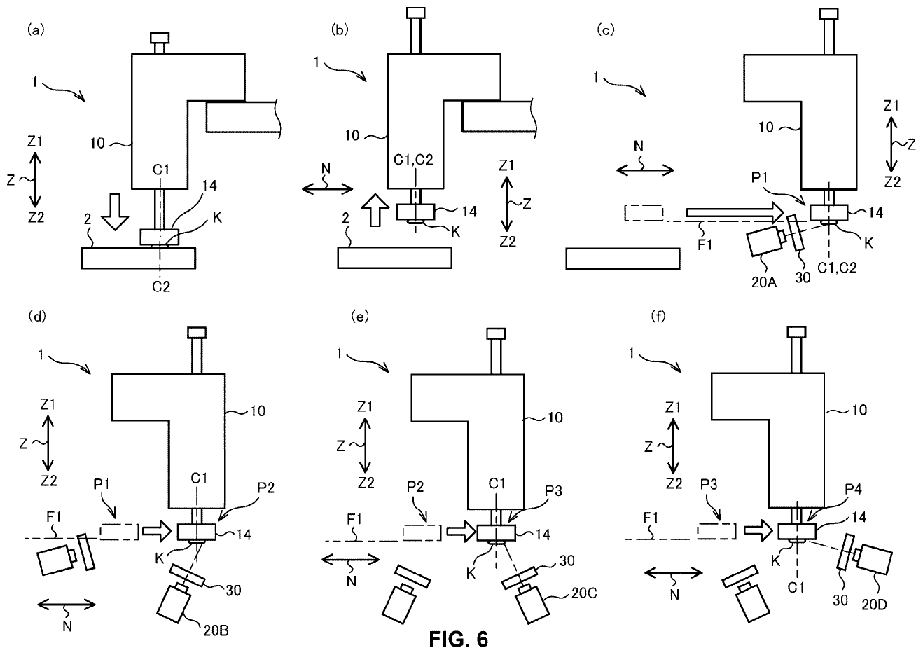

As will be described in detail later, the holding device 10 sequentially moves the O-ring K to four image-capturing positions P respectively corresponding to the four line sensor cameras 20 while holding the O-ring K (see FIG. 6). At each image-capturing position P, the holding device 10 rotates the head unit 14 about the rotation axis C1 to rotate the O-ring K in the circumferential direction.

### [Line Sensor Camera]

Next, the configuration of the line sensor camera 20 will be described. The O-ring appearance inspection apparatus 1 has a plurality of line sensor cameras 20 whose positions and orientations are preset. Note that when the orientations of the line sensor cameras 20 are set, the angles of the camera optical axes, which serve as the image-capturing center lines of the line sensor cameras 20, are also automatically determined. In the following description, the image-capturing center line of the line sensor camera 20 is referred to as the “camera optical axis L1”.

In the O-ring appearance inspection apparatus 1 of the present embodiment, four times of image-capturing are performed on one half toroidal portion of the O-ring K, and the four times of image-capturing cover the entire area of that one half toroidal portion of the O-ring K. The O-ring appearance inspection apparatus 1 has a plurality of line sensor cameras 20 (four in the present embodiment) corresponding to the four times of image-capturing. Specifically, as shown in FIG. 1, the O-ring appearance inspection apparatus 1 has a first line sensor camera 20A that performs first image-capturing, a second line sensor camera 20B that performs second image-capturing, a third line sensor camera 20C that performs third image-capturing, and a fourth line sensor camera 20D that performs fourth image-capturing with respect to one half toroidal portion of the O-ring K.

In the following description, the first line sensor camera 20A, the second line sensor camera 20B, the third line sensor camera 20C, and the fourth line sensor camera 20D are collectively referred to as “the line sensor camera 20”. In the following description, the camera optical axis L1 of the first line sensor camera 20A is referred to as “first camera optical axis L1a”, the camera optical axis L1 of the second line sensor camera 20B is referred to as “second camera optical axis L1b”, the camera optical axis L1 of the third line sensor camera 20C is referred to as “third camera optical axis L1c”, and the camera optical axis L1 of the fourth line sensor camera 20D is referred to as “fourth camera optical axis L1d”.

The line sensor camera 20 image-captures an image of the O-ring K. In the O-ring appearance inspection apparatus 1 of the present embodiment, the line sensor camera 20 is a line sensor camera that image-captures line images while moving a target object and combines the image-captured line images into a single image. The line sensor camera 20 has a plurality of light receiving elements configured to detect green light, red light, and blue light, respectively. The line sensor camera 20 image-captures the surface of the O-ring K by means of a light receiving element detecting light reflected from the surface of the O-ring K at the image-capturing position P (for example, light reflected from the inspection target portion S).

### [Image-Capturing Position]

The image-capturing position P is a position where the O-ring K is image-captured by the line sensor camera 20. More specifically, the image-capturing position P is a position where image-capturing is performed while rotating the O-ring K in the circumferential direction. As described above, in the O-ring appearance inspection apparatus 1, a plurality of line sensor cameras 20 are provided. Therefore, the O-ring appearance inspection apparatus 1 is configured to include a plurality of image-capturing positions P corresponding to the respective line sensor cameras 20. Specifically, as shown in FIG. 1, the O-ring appearance inspection apparatus 1 is configured with a first image-capturing position P1 corresponding to the first line sensor camera 20A, a second image-capturing position P2 corresponding to the second line sensor camera 20B, a third image-capturing position P3 corresponding to the third line sensor camera 20C, and a fourth image-capturing position P4 corresponding to the fourth line sensor camera 20D.

As shown in FIG. 1, in the O-ring appearance inspection apparatus 1 of the present embodiment, the plurality of image-capturing positions P are formed along one plane. Specifically, as shown in FIG. 1, the four image-capturing positions P are formed on the first virtual plane F1 intersecting the up-down direction Z. That is, in the present embodiment, each image-capturing position P is arranged at a position where the head unit 14 can move by the operation of the arm unit 12.

Further, in the O-ring appearance inspection apparatus 1 of the present embodiment, the focus of each line sensor camera 20 is fixed in advance at each image-capturing position P. The holding device 10 also moves the O-ring K to the image-capturing position P where the line sensor camera 20 is in focus, and rotates the head unit about the rotation axis at the image-capturing position P to rotate the rotating article in the circumferential direction.

Thus, in the O-ring appearance inspection apparatus 1, the focus of the line sensor camera 20 is fixed in advance, and the holding device 10 moves the O-ring K to that position. Therefore, in the O-ring appearance inspection apparatus 1, it is not necessary to adjust the focus of the line sensor camera 20 each time according to the size of the O-ring K. As a result, the O-ring appearance inspection apparatus 1 can improve inspection accuracy and shorten the takt time, thereby further enhancing the time efficiency of inspection.

Note that the rotating article appearance inspection apparatus of the present invention may allow the focus of the line sensor camera to be adjusted according to the size and type of the rotating article.

### [Position of Each Line Sensor Camera and the Angle of the Camera Optical Axis]

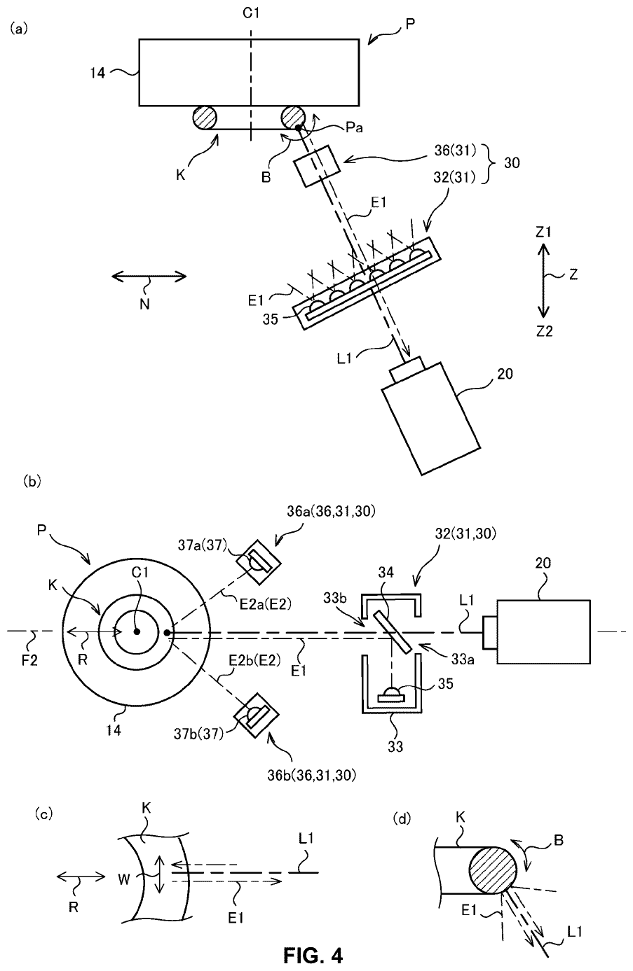

Next, the position of each line sensor camera 20 and the angle of the camera optical axis L1 of each line sensor camera 20 will be described with reference to FIG. 4. It can be said that the angle of the camera optical axis L1 is preset because the position and orientation of each line sensor camera 20 are preset. That is, in the O-ring appearance inspection apparatus 1, the line sensor cameras 20 are arranged in advance at fixed positions and orientations, and the O-ring K is moved by the holding device 10 to a position in front of the line sensor cameras 20 (the image-capturing position P).

As shown in FIG. 4(a), in the present embodiment, the line sensor camera 20 is arranged so as to generally face up or to the side. That is, in the present embodiment, the line sensor camera 20 is configured to image-capture the O-ring K from the lower direction (Z2). As shown in FIG. 4(a), the line sensor camera 20 is oriented and positioned such that the camera optical axis L1 is orthogonal to an image-capturing center position Pa of the O-ring K. As shown in FIG. 4(b), the line sensor camera 20 is arranged at an orientation (angle) and position such that the camera optical axis L1 extends along a second virtual plane F2 including the rotation axis C1 of the head unit 14.

As shown in FIG. 4(a), the line sensor camera 20 is arranged at a position farther from the first illumination unit 32 and the second illumination units 36 than the image-capturing position P. That is, the line sensor camera 20 is arranged at a position behind the first illumination unit 32 with respect to the O-ring K at the image-capturing position P, with the first illumination unit 32 interposed therebetween, which will be described later. In other words, the line sensor camera 20 is arranged at a position farther from the O-ring K at the image-capturing position P than the first illumination unit 32.

In the present embodiment, the camera optical axis L1 of each line sensor camera 20 is arranged at an angle with respect to the rotation axis C1. Further, the camera optical axis L1 of each line sensor camera 20 is preset so that its angle with respect to the rotation axis C1 is different. In more detail, the four line sensor cameras 20 are preset so that the angle of the camera optical axis L1 differs from the angle of the rotation axis C1 at the image-capturing position P (in the present embodiment, about 0 degrees with respect to the up-down direction Z), and their positions and postures are maintained at those angles. That is, in the O-ring appearance inspection apparatus 1, a plurality of line sensor cameras 20 are arranged such that the relative angles of the camera optical axes L1 with respect to the rotation axis C1 are different.

In the following description, the angle formed by the camera optical axis L1 and the rotation axis C1 (the relative angle of the camera optical axis L1 with respect to the rotation axis C1) is referred to as “relative angle D”. Further, the relative angle D between the first camera optical axis L1a and the rotation axis C1 is referred to as “first relative angle D1”, the relative angle D between the second camera optical axis L1b and the rotation axis C1 is referred to as “second relative angle D2”, the relative angle D between the third camera optical axis L1c and the rotation axis C1 is referred to as “third relative angle D3”, and the relative angle D between the fourth camera optical axis L1d and the rotation axis C1 is referred to as “fourth relative angle D4”.

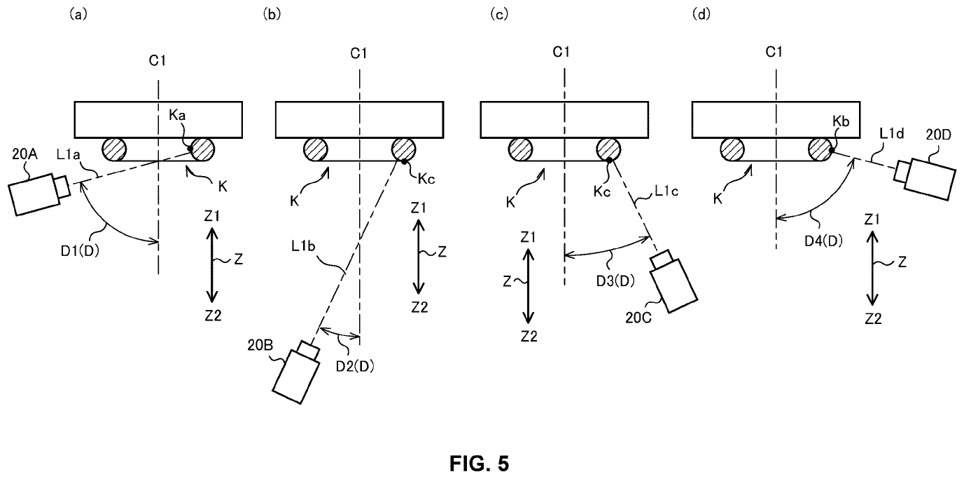

As shown in FIG. 5(a), the first camera optical axis L1a forms the first relative angle D1 (for example, an angle of 75 degrees (+75 degrees) clockwise in a front view) with respect to the rotation axis C1. That is, the first line sensor camera 20A is arranged such that the first camera optical axis L1a forms the first relative angle D1 with respect to the rotation axis C1. As shown in FIG. 5(a), the first line sensor camera 20A is oriented to capture an image of a portion of the inner peripheral surface including the inner end Ka.

As shown in FIG. 5(b), the second camera optical axis L1b forms the second relative angle D2 (for example, an angle of 25 degrees (+25 degrees) clockwise in a front view) with respect to the rotation axis C1. That is, the second line sensor camera 20B is arranged such that the second camera optical axis L1b forms the second relative angle D2 with respect to the rotation axis C1. As shown in FIG. 5(b), the second line sensor camera 20B is oriented to capture an image of a portion near the inner peripheral surface including the top Kc.

As shown in FIG. 5(c), the third camera optical axis L1c forms the third relative angle D3 (for example, an angle of 25 degrees (−25 degrees) counterclockwise in a front view) with respect to the rotation axis C1. That is, the third line sensor camera 20C is arranged such that the third camera optical axis L1c forms the third relative angle D3 with respect to the rotation axis C1. As shown in FIG. 5(c), the third line sensor camera 20C is oriented to capture an image of a portion near the outer peripheral surface including the top Kc.

As shown in FIG. 5(d), the fourth camera optical axis L1d forms the fourth relative angle D4 (for example, an angle of 75 degrees (−75 degrees) counterclockwise in a front view) with respect to the rotation axis C1. That is, the fourth line sensor camera 20D is arranged such that the fourth camera optical axis L1d forms the fourth relative angle D4 with respect to the rotation axis C1. As shown in FIG. 5(d), the fourth line sensor camera 20D is oriented to capture an image of a portion of the outer peripheral surface including the outer end Kb.

The relative angle D illustrated in the present embodiment is merely an example. The relative angle D of the camera optical axis L1 of each line sensor camera 20 with respect to the rotation axis C1 can be appropriately set depending on the number of line sensor cameras 20, the size of the O-ring K, the number of times the O-ring K is image-captured on one half toroidal portion thereof, and the like. Further, the number of times one half toroidal portion of the O-ring K is image-captured can be appropriately selected according to the relative angle or the like.

### [Illumination Device]

As shown in FIG. 1, the O-ring appearance inspection apparatus 1 of the present embodiment has a plurality of illumination devices 30 (four in the present embodiment), each corresponding to one of the plurality of line sensor cameras 20 (four in the present embodiment), for emitting light toward the O-ring K at the image-capturing position P.

The illumination device 30 includes at least one illumination unit 31 that emits light toward the O-ring K at the image-capturing position P. In the present embodiment, each illumination device 30 has a plurality of illumination units 31 (three in the present embodiment). Specifically, as shown in FIG. 4(b), the illumination device 30 includes, as the illumination units 31, one first illumination unit 32 and two second illumination units 36.

As shown in FIG. 4(b), the first illumination unit 32 includes a housing 33, a half mirror 34, and light sources 35. The housing 33 includes a first opening 33a formed at a position facing the line sensor camera 20 and a second opening 33b formed at a position facing the first opening 33a. The first illumination unit 32 has a configuration in which the half mirror 34 and the light sources 35 are accommodated within the housing 33. The half mirror 34 is arranged at an angle of 45 degrees with respect to the illumination direction of the light emitted from the light sources 35. As shown in FIG. 4(b), the first illumination unit 32 reflects the first illumination light E1 by 90 degrees using the half mirror 34 and irradiates the O-ring K at the image-capturing position P with the reflected light from the second opening 33b. On the other hand, the light entering from the second opening 33b (the first illumination light E1 reflected from the surface of the O-ring K) passes through the half mirror 34, is emitted outward from the first opening 33a, and enters the line sensor camera 20.

As shown in FIG. 4(a), the first illumination unit 32 includes a plurality of light sources 35. In the present embodiment, the light sources 35 of the first illumination unit 32 are each an LED that emits green light. Therefore, the first illumination light E1 emitted from the first illumination unit 32 is green light. In other words, the first illumination unit 32 emits the first illumination light E1 of green color.

As shown in FIG. 4(a), the first illumination unit 32 is arranged at a greater distance from the image-capturing position P than the second illumination units 36. That is, the first illumination unit 32 is arranged farther from the image-capturing position P than the second illumination units 36. Accordingly, as shown in FIG. 4(c), the first illumination light E1 that reaches the O-ring K at the image-capturing position P has a smaller angle of incidence in the width direction W, which intersects both the radial direction R and the central axis C2. Therefore, the line sensor camera 20 image-captures a narrow band-shaped region in the width direction W of the O-ring K. Here, the surface of the mirror-finished O-ring K strongly exhibits the characteristic of specular reflection. Therefore, the first illumination light E1 emitted from the first illumination unit 32 toward the O-ring K enters the line sensor camera 20 while maintaining a high degree of parallelism with the camera optical axis L1.

Further, as described above, in the first illumination unit 32, a plurality of light sources 35 are arranged to form a row. As shown in FIG. 4(a), the plurality of light sources 35 are arranged to illuminate a portion of the O-ring K in the cross-sectional circumferential direction B. Specifically, as shown in FIG. 4(a), the plurality of light sources 35 are arranged along a direction that intersects the camera optical axis L1. Therefore, the first illumination light E1 enters the O-ring K at the image-capturing position P within a certain range in the cross-sectional circumferential direction B. In other words, the first illumination unit 32 emits the first illumination light E1 onto the O-ring K within a predetermined range according to its curved surface. Further, on the surface of the mirror-finished O-ring K, the incident light is reflected specularly according to the curved surface of the O-ring K. Therefore, as shown in FIG. 4(d), a portion of the first illumination light E1 emitted from the first illumination unit 32 toward the O-ring K is reflected so as to travel along the camera optical axis L1 and enters the line sensor camera 20.

Thus, the first illumination unit 32 is configured to emit light having a high degree of parallelism (light having high directivity) toward the O-ring K. Further, the first illumination unit 32 is configured to emit light (specularly reflected light) that is specularly reflected on the surface of the O-ring K.

Here, when the surface of the mirror-finished O-ring K is normal without scratches, scuffs, or other abnormalities, most of the light specularly reflected from the surface of the O-ring K enters the line sensor camera 20. On the other hand, when a defective portion such as a dent or a scratch exists on the surface of the O-ring K, the first illumination light E1 is diffusely reflected at the defective portion, and the diffusely reflected light from that portion does not enter the line sensor camera 20.

Such a phenomenon makes it possible to produce a difference between the amount of light reflected from the normal portion and entering the line sensor camera 20 and the amount of light reflected from the defective portion and entering the line sensor camera 20, even when the defect on the surface of the mirror-finished O-ring K, such as a shallow dent or scuff, is difficult to detect using diffused light. Further, in the O-ring appearance inspection apparatus 1, defective portions can be detected based on such differences in the amount of light. Therefore, the O-ring appearance inspection apparatus 1 can detect slight variation such as surface scuffs and shallow scratches. As a result, the O-ring appearance inspection apparatus 1 can further enhance inspection accuracy.

As shown in FIG. 4(b), the second illumination units 36 include light sources 37. As shown in FIG. 4(b), in the present embodiment, two second illumination units 36 are provided for a first illumination unit 32. As shown in FIG. 4(b), the two second illumination units 36 are arranged symmetrically with respect to the camera optical axis L1 in a plan view. In other words, the two second illumination units 36 are arranged so as to be positioned on opposite sides of the camera optical axis L1. The second illumination units 36 each emits light having a color different from that of the first illumination unit 32. Specifically, among the two second illumination units 36, the light source 37a provided in one of the second illumination units 36a is an LED that emits blue light. The light source 37b provided in the other second illumination unit 36b is an LED that emits red light.

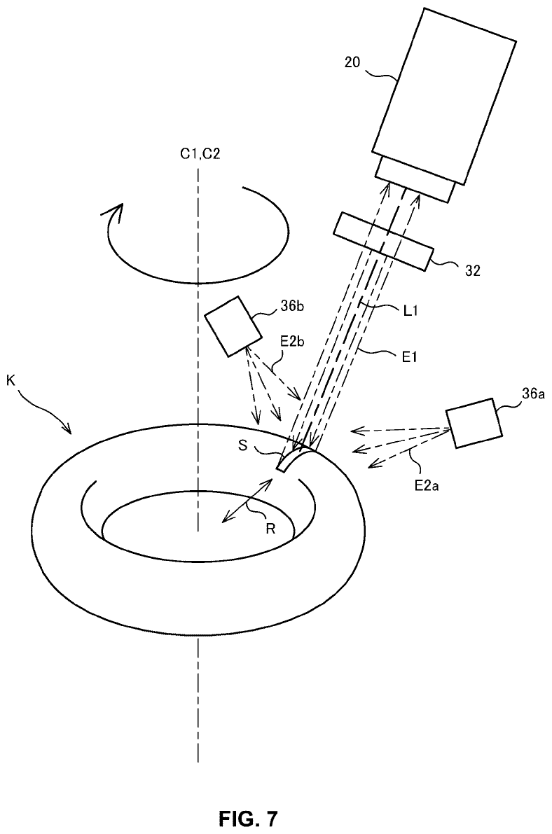

As shown in FIG. 4(a), the second illumination units 36 are each arranged at a shorter distance from the image-capturing position P than the first illumination unit 32. That is, the second illumination units 36 are each arranged closer to the image-capturing position P than the first illumination unit 32. Therefore, the light (second illumination light E2) emitted from the second illumination units 36 is emitted so as to diffuse toward the O-ring K at the image-capturing position P (see FIG. 7). In other words, the second illumination units 36 each emits light having a low degree of parallelism (light having low directivity) toward the O-ring K, as compared with the first illumination unit 32. Further, the second illumination units 36 are each configured to emit light having a high degree of diffusion (diffused light).

Thus, the O-ring appearance inspection apparatus 1 of the present embodiment includes the first illumination unit 32 that emits light having a high degree of parallelism (specularly reflected light) toward the line sensor camera 20, and the second illumination units 36 that emit light having a low degree of parallelism (diffused light) toward the line sensor camera 20. In the O-ring appearance inspection apparatus 1, a plurality of illumination devices 30 provided corresponding to a plurality of line sensor cameras 20 include the first illumination unit 32 that emits green light and the second illumination units 36 that emit light having a color different from that of the first illumination unit 32. Further, the first illumination unit 32 is arranged so that its distance from the image-capturing position P is greater than those of the second illumination units 36.

Here, when a defective portion such as a dent or a scratch exists on the O-ring K, its edge portion (wall portion) is illuminated by the second illumination light E2a and the second illumination light E2b, and the reflected light from the edge portion enters the line sensor camera 20. Thus, the O-ring appearance inspection apparatus 1 can detect abnormalities such as scratches or dents. Therefore, the O-ring appearance inspection apparatus 1 can simultaneously detect both ordinary scratches and slight variation such as surface scuffs and shallow scratches that cannot be detected by the light from the second illumination units 36.

### [Control Device]

The control device 40 controls the operation of the entire apparatus and determines whether the O-ring K is acceptable or defective based on the image captured by the line sensor camera 20. The control device 40 includes, as hardware components, a CPU (Central Processing Unit), a RAM (Random Access Memory), and a ROM (Read Only Memory), which are not shown. In such a hardware configuration, the CPU performs computations according to a predetermined program, and the control device 40 executes operations according to the loaded program.

The control device 40 includes functional units configured to execute various operations according to the program. For example, as shown in FIG. 1, the control device 40 includes an operation control unit 41 and a determination unit 42 as functional units. The operation control unit 41 controls the operations of respective components such as the holding device 10, the line sensor camera 20, and the illumination device 30. The determination unit 42 processes images of green light, red light, and blue light captured by each line sensor camera 20, and determines from the luminance levels whether defects such as dents or scratches are present on the O-ring K.

### [Operation of O-Ring Appearance Inspection Apparatus]

Next, the operation of the O-ring appearance inspection apparatus 1 will be described with reference to FIG. 6. The following operation of the O-ring appearance inspection apparatus 1 is performed under the control of the control device 40 (operation control unit 41). Further, the operation of the O-ring appearance inspection apparatus 1 described below can be said to correspond to each step of a method for performing an appearance inspection of the O-ring K (a rotating article appearance inspection method). Specifically, the O-ring appearance inspection method includes a step of holding the O-ring K (holding step), a step of moving the O-ring K (moving step), and a step of rotating the O-ring K and image-capturing the same (image-capturing step).

The O-ring appearance inspection apparatus 1 first operates the holding device 10 to pick up the O-ring K placed on the mounting surface 2 (holding step). Specifically, as shown in FIG. 6(a), the O-ring appearance inspection apparatus 1 presses the head unit 14 against the O-ring K placed on the mounting surface 2 to bring the O-ring K into tight contact with the tack surface body 16 (see FIG. 3). At this time, the holding device 10 moves the head unit 14 in the up-down direction Z for movement between the mounting surface 2 and the first virtual plane F1 (pickup/release operation). A position identification camera (not shown) is provided in the head unit 14. The position of the central axis C2 of the O-ring K is extracted by the position identification camera, and the head unit 14 is pressed against the O-ring K at a position where the rotation axis C1 and the central axis C2 are aligned. When the head unit 14 is pressed against the O-ring K, the tack surface body 16 is pressed against the O-ring K and elastically deforms, and the tack surface body 16 comes into tight contact with the O-ring K. The O-ring K is held by the head unit 14 through the tackiness of the tack surface body 16 and the negative pressure of the suction port 18.

As shown in FIG. 6(b), the O-ring appearance inspection apparatus 1 raises the head unit 14 after the O-ring K is held by the head unit 14. As shown in FIG. 6(b), in the present embodiment, in a state where the O-ring K is held by the head unit 14, the head unit 14 faces down.

As shown in FIG. 6(c), the O-ring appearance inspection apparatus 1 moves the head unit 14 to the first image-capturing position P1 while holding the O-ring K in a state where the rotation axis C1 and the central axis C2 are aligned, and maintaining the orientation of the head unit 14 (the posture of the O-ring K) facing downward Z2 (first moving step). Specifically, in the O-ring appearance inspection apparatus 1 of the present embodiment, the holding device 10 holds the O-ring K in tight contact with the tack surface body 16, and then raises the head unit 14 to a position having the same height as the first image-capturing position P1 (first virtual plane F1) (see FIG. 6(b)). Next, the holding device 10 moves the head unit 14 in the lateral direction N within the first virtual plane F1 (movement operation between image-capturing positions). That is, after the holding device 10 holds the O-ring K and raises it to the first virtual plane F1, the holding device 10 moves the head unit 14 in the lateral direction N to move to the first image-capturing position P1 (movement operation between image-capturing positions).

The O-ring appearance inspection apparatus 1 image-captures the O-ring K while maintaining the position of the head unit 14 at the first image-capturing position P1. Specifically, the O-ring appearance inspection apparatus 1 emits light toward the O-ring K by the first illumination unit 32 and the second illumination units 36 while maintaining the position and posture of the O-ring K at the first image-capturing position P1. Further, at the first image-capturing position P1, the O-ring appearance inspection apparatus 1 rotates the head unit 14 about the rotation axis C1 while maintaining the rotation axis C1 and the central axis C2 in alignment, and image-captures the O-ring K (head unit rotation operation). Thus, light is emitted onto a portion (inspection target portion S) of the O-ring K relative to a radial direction R, and the entire circumference of that portion is image-captured in the circumferential direction (first image-capturing step). Further, the position and range of the inspection target portion S captured by the first line sensor camera 20A will be described in detail later.

When the image-capturing at the first image-capturing position P1 is completed, the O-ring appearance inspection apparatus 1 moves the O-ring K to the second image-capturing position P2 (second moving step). Specifically, as shown in FIG. 6(d), the O-ring appearance inspection apparatus 1 holds the O-ring K in a state where the rotation axis C1 and the central axis C2 are aligned, and moves the head unit 14 from the first image-capturing position P1 to the second image-capturing position P2 in the lateral direction N while maintaining the orientation of the head unit 14 (the posture of the O-ring K) facing downward Z2 (movement operation between image-capturing positions).

Similar to the operation at the first image-capturing position P1, the O-ring appearance inspection apparatus 1 rotates the head unit 14 about the rotation axis C1 while maintaining the position of the O-ring K at the second image-capturing position P2, thereby rotating the O-ring K in the circumferential direction and image-capturing the same (second image-capturing step). Further, the position and range of the inspection target portion S captured by the second line sensor camera 20B will be described in detail later.

When the image-capturing at the second image-capturing position P2 is completed, the O-ring appearance inspection apparatus 1 moves the O-ring K to the third image-capturing position P3 (third moving step). Specifically, as shown in FIG. 6(e), the O-ring appearance inspection apparatus 1 holds the O-ring K in a state where the rotation axis C1 and the central axis C2 are aligned, and moves the head unit 14 from the second image-capturing position P2 to the third image-capturing position P3 in the lateral direction N while maintaining the orientation of the head unit 14 (the posture of the O-ring K) facing downward Z2 (movement operation between image-capturing positions).

Similar to the operation at the first image-capturing position P1, the O-ring appearance inspection apparatus 1 rotates the head unit 14 about the rotation axis C1 while maintaining the position of the O-ring K at the third image-capturing position P3, thereby rotating the O-ring K in the circumferential direction and image-capturing the same (third image-capturing step). Further, the position and range of the inspection target portion S captured by the third line sensor camera 20C will be described in detail later.

When the image-capturing at the third image-capturing position P3 is completed, the O-ring appearance inspection apparatus 1 moves the O-ring K to the fourth image-capturing position P4 (fourth moving step). Specifically, as shown in FIG. 6(f), the O-ring appearance inspection apparatus 1 holds the O-ring K in a state where the rotation axis C1 and the central axis C2 are aligned, and moves the head unit 14 from the third image-capturing position P3 to the fourth image-capturing position P4 in the lateral direction N while maintaining the orientation of the head unit 14 (the posture of the O-ring K) facing downward Z2 (movement operation between image-capturing positions).

Similar to the operation at the first image-capturing position P1, the O-ring appearance inspection apparatus 1 rotates the head unit 14 about the rotation axis C1 while maintaining the position of the O-ring K at the fourth image-capturing position P4, thereby rotating the O-ring K in the circumferential direction and image-capturing the same (fourth image-capturing step). Further, the position and range of the inspection target portion S captured by the fourth line sensor camera 20D will be described in detail later.

When image-capturing at the fourth image-capturing position P4 is completed, the O-ring appearance inspection apparatus 1 discharges air from the suction port 18 to temporarily remove the O-ring K, inverts the O-ring K upside down, and image-captures the other surface of the O-ring K in the same manner.

The images captured by each line sensor camera 20 are transmitted to the control device 40, where the control device 40 (determination unit 42) processes the images and determines, based on the luminance level, whether defects such as dents or scratches are present on the O-ring K.

In the O-ring appearance inspection apparatus 1, by moving the O-ring K between a plurality of image-capturing positions P corresponding to a plurality of line sensor cameras 20 whose positions and orientations are preset, it becomes unnecessary to adjust the angle of the O-ring K at each image-capturing position P. Therefore, in the O-ring appearance inspection apparatus 1, it is possible not only to suppress the occurrence of angular misalignment during angular adjustment of the O-ring K but also to shorten the takt time required for the angular adjustment of the O-ring K. As a result, the O-ring appearance inspection apparatus 1 can improve inspection accuracy and shorten the takt time, thereby enhancing the time efficiency of inspection.

In the O-ring appearance inspection apparatus 1, the line sensor camera 20 is configured as a line sensor camera. Further, the holding device 10 has a head unit 14 that is rotatable about the rotation axis C1, and at each image-capturing position P, the head unit 14 is rotated about the rotation axis C1 to rotate the O-ring K in the circumferential direction.

Thus, in the O-ring appearance inspection apparatus 1, it is possible to image-capture the entire circumference of a portion in the radial direction R of the O-ring K. Therefore, in the O-ring appearance inspection apparatus 1, it is possible to detect scratches and the like with higher accuracy as compared with the case of image-capturing by an area camera. As a result, the O-ring appearance inspection apparatus 1 can improve inspection accuracy and shorten the takt time, thereby further enhancing the time efficiency of inspection.

As described above, the O-ring appearance inspection apparatus 1 sequentially moves the O-ring K to a plurality of image-capturing positions P while maintaining the posture of the O-ring K by the holding device 10, and at each image-capturing position P, rotates the head unit 14 about the rotation axis C1 to rotate the O-ring K in the circumferential direction.

Thus, in the O-ring appearance inspection apparatus 1, by moving the O-ring K between a plurality of image-capturing positions P and rotating the same in the circumferential direction at each image-capturing position P while maintaining its posture, it becomes unnecessary to adjust the angle of the head unit 14 at each image-capturing position P. Therefore, in the O-ring appearance inspection apparatus 1, it is possible not only to suppress the occurrence of angular misalignment during angular adjustment of the head unit 14 but also to shorten the takt time required for the angular adjustment of the head unit 14. As a result, the O-ring appearance inspection apparatus 1 can improve inspection accuracy and shorten the takt time, thereby enhancing the time efficiency of inspection.

In the O-ring appearance inspection apparatus 1, the holding device 10 has a head unit 14 that is rotatable about the rotation axis C1, and in both the movement operation between image-capturing positions P of the O-ring K (movement operation between image-capturing positions) and the rotation operation of the head unit 14 (head unit rotation operation), the head unit 14 faces obliquely down or down.

Therefore, in the O-ring appearance inspection apparatus 1, it is unnecessary to orient the head unit 14 upward during the movement operation between the image-capturing positions P and the rotation operation at each image-capturing position P after picking up the O-ring K, and furthermore, the takt time required to adjust the angle of the head unit 14 can be shortened. As a result, the O-ring appearance inspection apparatus 1 can improve inspection accuracy and further enhancing the time efficiency of inspection.

In the O-ring appearance inspection apparatus 1, the plurality of image-capturing positions P are formed along one plane (first virtual plane F1). Further, the holding device 10 is a horizontal multi-joint robot that moves the O-ring K between a plurality of image-capturing positions P formed along the first virtual plane F1.

Thus, in the O-ring appearance inspection apparatus 1, by configuring the plurality of image-capturing positions P in the lateral direction N and employing a horizontal multi-joint robot with a simple configuration, it is possible to simplify the operation of the holding device 10 when moving the O-ring K between the image-capturing positions P. As a result, the O-ring appearance inspection apparatus 1 can improve inspection accuracy and shorten the takt time, thereby further enhancing the time efficiency of inspection.

### [Inspection Target Portion Inspected by Each Line Sensor Camera]

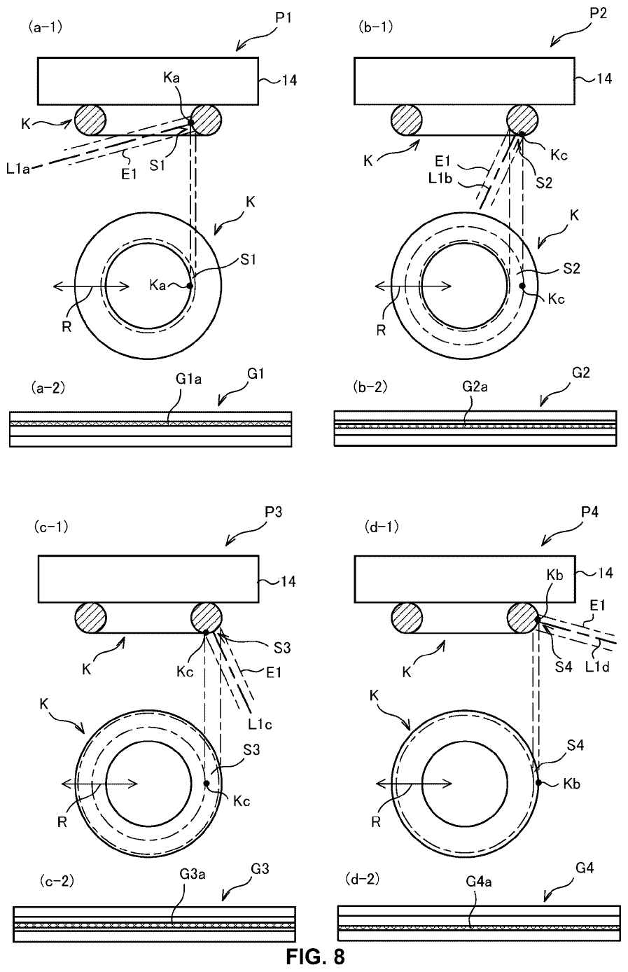

With reference to FIG. 7 and FIG. 8, the inspection target portion S at each image-capturing position P will be described below.

In the O-ring appearance inspection apparatus 1, the O-ring K is divided into a plurality of portions (four portions) in the radial direction R, and these portions are image-captured by the corresponding line sensor cameras 20. In the O-ring appearance inspection apparatus 1, one half toroidal portion of the O-ring K can be inspected without any portion left uninspected by setting the angles of the plurality of line sensor cameras 20 (four in the present embodiment) according to the plurality of portions in the radial direction R (cross-sectional circumferential direction B) of the O-ring K. That is, in the O-ring appearance inspection apparatus 1, one half toroidal portion of the O-ring K can be inspected without any portion left uninspected by image-capturing the surface of the O-ring K multiple times at different angles.

As described above, the O-ring appearance inspection apparatus 1 is configured that at least a part of the light from the first illumination unit 32 is specularly reflected on the surface of the O-ring K so that the reflected light enters the line sensor camera 20. In the O-ring appearance inspection apparatus 1, a slight variation in the O-ring K can be detected by causing the light from the first illumination unit 32 to enter the line sensor camera 20 along the camera optical axis L1 (by causing specularly reflected light to enter).

Therefore, as shown in FIG. 7, the portion of the O-ring K that reflects the first illumination light E1 as specularly reflected light (light having a high degree of parallelism) can be regarded as the portion to be inspected in the O-ring appearance inspection apparatus 1. From a reverse point of view, the inspection target portion can be regarded as the portion that specularly reflects the light of the first illumination light E1 toward the line sensor camera 20. In the following description, the portion of the O-ring K that reflects the first illumination light E1 as specularly reflected light (light having a high degree of parallelism) is referred to as “inspection target portion S”.

Further, the inspection target portion S captured by the first line sensor camera 20A is referred to as “first inspection target portion S1”, the inspection target portion S captured by the second line sensor camera 20B is referred to as “second inspection target portion S2”, the inspection target portion S captured by the third line sensor camera 20C is referred to as “third inspection target portion S3”, and the inspection target portion S captured by the fourth line sensor camera 20D is referred to as “fourth inspection target portion S4”, respectively.

As shown in FIG. 8(a−1), the first camera optical axis L1a is set at an angle and position for image-capturing a portion of the inner peripheral surface including the inner end Ka in the radial direction R of the O-ring K. Further, as shown in FIG. 8(a−1), the first illumination light E1 that is specularly reflected at a portion of the inner peripheral surface including the inner end Ka enters the first line sensor camera 20A along the first camera optical axis L1a. Therefore, of the O-ring K, the portion of the inner peripheral surface including the inner end Ka can be regarded as the first inspection target portion S1 that reflects the light of the first illumination light E1 toward the first line sensor camera 20A along the first camera optical axis L1a.

The O-ring appearance inspection apparatus 1 image-captures the O-ring K with the first line sensor camera 20A by rotating the head unit 14 while irradiating the first inspection target portion S1 with the first illumination light E1 so as to include the entire circumference of the first inspection target portion S1 in the circumferential direction. Further, as shown in FIG. 8(a−2), the O-ring appearance inspection apparatus 1 obtains, as an image-capturing result, a first image G1 including an image of the entire circumference of the first inspection target portion S1 (a first illuminated image portion G1a) in the circumferential direction, to which light having a high degree of parallelism is emitted by the image-capturing of the first line sensor camera 20A.

As shown in FIG. 8(b−1), the second camera optical axis L1b is set at an angle and position for image-capturing a portion near the inner peripheral surface including the top Kc in the radial direction R of the O-ring K. Further, as shown in FIG. 8(b−1), the first illumination light E1 that is specularly reflected at a portion near the inner peripheral surface including the top Kc enters the second line sensor camera 20B along the second camera optical axis L1b. Therefore, of the O-ring K, the portion near the inner peripheral surface including the top Kc can be regarded as the second inspection target portion S2 that reflects the light of the first illumination light E1 toward the second line sensor camera 20B along the second camera optical axis L1b.

The O-ring appearance inspection apparatus 1 image-captures the O-ring K with the second line sensor camera 20B by rotating the head unit 14 while irradiating the second inspection target portion S2 with the first illumination light E1 so as to include the entire circumference of the second inspection target portion S2 in the circumferential direction. Further, as shown in FIG. 8(b−2), the O-ring appearance inspection apparatus 1 obtains, as an image-capturing result, a second image G2 including an image of the entire circumference of the second inspection target portion S2 (a second illuminated image portion G2a) in the circumferential direction, to which light having a high degree of parallelism is emitted by the image-capturing of the second line sensor camera 20B.

As shown in FIG. 8(c−1), the third camera optical axis L1c is set at an angle and position for image-capturing a portion near the outer peripheral surface including the top Kc in the radial direction R of the O-ring K. Further, as shown in FIG. 8(c−1), the first illumination light E1 that is specularly reflected at a portion near the outer peripheral surface including the top Kc enters the third line sensor camera 20C along the third camera optical axis L1c. Therefore, of the O-ring K, the portion near the outer peripheral surface including the top Kc can be regarded as the third inspection target portion S3 that reflects the light of the first illumination light E1 toward the third line sensor camera 20C along the third camera optical axis L1c.

The O-ring appearance inspection apparatus 1 image-captures the O-ring K with the third line sensor camera 20C by rotating the head unit 14 while irradiating the third inspection target portion S3 with the first illumination light E1 so as to include the entire circumference of the third inspection target portion S3 in the circumferential direction. Further, as shown in FIG. 8(c−2), the O-ring appearance inspection apparatus 1 obtains, as an image-capturing result, a third image G3 including an image of the entire circumference of the third inspection target portion S3 (a third illuminated image portion G3a) in the circumferential direction, to which light having a high degree of parallelism is emitted by the image-capturing of the third line sensor camera 20C.

As shown in FIG. 8(d−1), the fourth camera optical axis L1d is set at an angle and position for image-capturing a portion of the outer peripheral surface including the outer end Kb in the radial direction R of the O-ring K. At the fourth image-capturing position P4, the first illumination light E1 is emitted toward the O-ring K by the first illumination unit 32. Further, as shown in FIG. 8(d−1), the first illumination light E1 that is specularly reflected at a portion of the outer peripheral surface including the outer end Kb enters the fourth line sensor camera 20D along the fourth camera optical axis L1d. Therefore, of the O-ring K, the portion of the outer peripheral surface including the outer end Kb can be regarded as the fourth inspection target portion S4 that reflects the light of the first illumination light E1 toward the fourth line sensor camera 20D along the fourth camera optical axis L1d.

The O-ring appearance inspection apparatus 1 image-captures the O-ring K with the fourth line sensor camera 20D by rotating the head unit 14 while irradiating the fourth inspection target portion S4 with the first illumination light E1 so as to include the entire circumference of the fourth inspection target portion S4 in the circumferential direction. Further, as shown in FIG. 8(d−2), the O-ring appearance inspection apparatus 1 obtains, as an image-capturing result, a fourth image G4 including an image of the entire circumference of the fourth inspection target portion S4 (a fourth illuminated image portion G4a) in the circumferential direction, to which light having a high degree of parallelism is emitted by the image-capturing of the fourth line sensor camera 20D.

Thus, in the O-ring appearance inspection apparatus 1, a portion (inspection target portion S) in the radial direction R of the O-ring K, which rotates in the circumferential direction at the image-capturing position P, is image-captured over the entire circumference, and the image-capturing results based on the four patterns of relative angles D are configured to include the entire area of one half toroidal portion of the O-ring K. Further, the four image-capturing results include images (images of the inspection target portions S) of portions where specularly reflected light (light having a high degree of parallelism) is reflected, covering the entire area of one half toroidal portion of the O-ring K. Thus, in the O-ring appearance inspection apparatus 1, one half toroidal portion of the O-ring K can be inspected with high accuracy and without leaving any portion uninspected.

Further, in the O-ring appearance inspection apparatus 1, the O-ring K is held while ensuring a large exposed area of the O-ring K so that both the inner end Ka and the outer end Kb are exposed by keeping the O-ring K in tight contact with the tack surface body 16. Therefore, the O-ring appearance inspection apparatus 1 can overlap the inner end Ka and outer end Kb in the inspection results on both sides. As a result, the O-ring appearance inspection apparatus 1 enables high-accuracy appearance inspection without leaving any portion uninspected.

Further, in the O-ring appearance inspection apparatus 1, the four line sensor cameras 20 are arranged such that their positions and the angles of their camera optical axes L1 allow each of them to image-capture, at the image-capturing position P, a portion (inspection target portion S) in the radial direction R of the O-ring K rotating in the circumferential direction, over the entire circumference, and the image-capturing results of the four line sensor cameras 20 include the entire area of one half toroidal portion of the O-ring K. In the O-ring appearance inspection apparatus 1, image-capturing is performed at each image-capturing position P with the rotation axis C1 of the head unit 14 aligned with the central axis C2 of the O-ring K, and with the posture of the O-ring K maintained.

Thus, the O-ring appearance inspection apparatus 1 can image-capture one half toroidal portion of the O-ring K without omission while suppressing a relative angular misalignment between the rotation axis C1 of the head unit 14 and the camera optical axis L1, thereby improving the accuracy of the appearance inspection. As a result, the O-ring appearance inspection apparatus 1 can improve inspection accuracy and shorten the takt time, thereby enhancing the time efficiency of inspection.

Although the embodiments of the O-ring appearance inspection apparatus of the present invention have been described above, the O-ring appearance inspection apparatus of the present invention is not limited to the embodiments described above.

In the embodiments described above, although an example is shown in which the rotation axis C1 of the head unit 14 is arranged along the up-down direction Z, the orientation of the rotation axis C1 is not limited to the up-down direction. That is, the orientation of the rotation axis of the head unit can be variously selected. For example, the rotation axis of the head unit may be configured to be inclined with respect to the up-down direction, or may be configured in the lateral direction.

In the embodiments described above, although an example is shown in which the tack surface body 16, the negative pressure chamber 15, and the suction port 18 are provided in the head unit 14, the configuration for holding the O-ring is not limited to this embodiment. That is, the O-ring may be held by a configuration other than using a tack surface body or suction.

In the embodiments described above, although an example is shown in which four line sensor cameras 20 are provided, the O-ring appearance inspection apparatus of the present invention only needs to be provided with a plurality of line sensor cameras. That is, the number of line sensor cameras may be two, three, or five or more.

In the embodiments described above, although an example is shown in which one inspection target portion S is image-captured by one line sensor camera 20, the O-ring appearance inspection apparatus of the present invention may be configured to image-capture a plurality of inspection target portions with one line sensor camera. For example, an O-ring may be positioned at a plurality of positions with respect to a single camera, and a plurality of portions of the O-ring (for example, an outer peripheral surface and an inner peripheral surface) may be image-captured with a single line sensor camera.

In the embodiments described above, although one half toroidal portion of the O-ring is image-captured with four line sensor cameras and the O-ring is inverted to image-capture the other side, line sensor cameras for image-capturing both sides of the O-ring may be respectively provided. For example, one half toroidal portion of the O-ring may be image-captured with a plurality of line sensor cameras (for example, four), and another plurality of line sensor cameras (for example, four) may be provided to image-capture the other side.

In the embodiments described above, although an example is shown in which one half toroidal portion of the O-ring K is image-captured four times so as to cover one half toroidal portion of the O-ring K, the apparatus may be configured to perform image-capturing three times on one half toroidal portion of the O-ring, or five or more times of image-capturing.

In the embodiments described above, although an example is shown in which an illumination device 30 is provided for each line sensor camera 20 so as to correspond to each line sensor camera 20, the O-ring appearance inspection apparatus of the present invention is not limited to the embodiments described above. For example, an illumination device common to a plurality of line sensor cameras may be provided. For example, one illumination device common to these line sensor cameras may be provided to correspond to the plurality of line sensor cameras.

In the embodiments described above, although an example is shown in which a second illumination units 36 are provided in addition to the first illumination unit 32, a configuration without the second illumination unit may also be employed. Also, in the embodiments described above, although an example is shown in which the second illumination unit emits diffused light, the second illumination unit may be configured to emit light having a high degree of parallelism. Further, in the embodiments described above, although an example is shown in which the first illumination unit 32 emits green light and the second illumination units 36 emit red light and blue light, the colors of the light emitted from the first and second illumination units are not limited to the embodiments described above, and the colors of the light from the first and second illumination units can be appropriately selected.

While one embodiment of the present invention has been described above, the specific aspects that the invention can take are not limited to the embodiment described above.

### LISTING OF REFERENCE CHARACTERS

1 O-Ring Appearance Inspection Apparatus
10 Holding Device
12 Arm Unit
14 Head Unit
20 Line Sensor Camera
20A First Line Sensor Camera (Line Sensor Camera)
20B Second Line Sensor Camera (Line Sensor Camera)
20C Third Line Sensor Camera (Line Sensor Camera)
20D Fourth Line Sensor Camera (Line Sensor Camera)
30 Illumination Device
31 Illumination Unit (Illumination Device)
32 First Illumination Unit (Illumination Device, Illumination Unit)
36 Second Illumination Unit (Illumination Device, Illumination Unit)
36a Second Illumination Unit (Illumination Device, Illumination Unit)
36b Second Illumination Unit (Illumination Device, Illumination Unit)
C1 Rotation Axis
C2 Central Axis
D1 Angle
D2 Angle
D3 Angle
D4 Angle
G1 First Image (Imaging Result)
G2 Second Image (Imaging Result)
G3 Third Image (Imaging Result)
G4 Fourth Image (Imaging Result)
K O-ring
L1 Camera Optical Axis
L1a First Camera Optical Axis (Camera Optical Axis)
L1b Second Camera Optical Axis (Camera Optical Axis)
L1c Third Camera Optical Axis (Camera Optical Axis)
L1d Fourth Camera Optical Axis (Camera Optical Axis)
P Image-capturing position
P1 First Image-capturing position (Image-capturing position)
P2 Second Image-capturing position (Image-capturing position)
P3 Third Image-capturing position (Image-capturing position)
P4 Fourth Image-capturing position (Image-capturing position)

1. An appearance inspection apparatus for inspecting a rotating article having a shape of a rotating body, the apparatus comprising:
a plurality of line sensor cameras of which the positions and orientations are preset and image-capture the rotating article; and
a holding device that is a robot having fewer than six axes, holds the rotating article, and has a head unit rotatable about its rotation axis, wherein
the holding device sequentially moves the rotating article to a plurality of image-capturing positions respectively corresponding to the plurality of line sensor cameras, and rotates the head unit about its rotation axis at each image-capturing position to rotate the rotating article in its circumferential direction.

2. The rotating article appearance inspection apparatus of claim 1, wherein the holding device sequentially moves the rotating article to a plurality of the image-capturing positions while maintaining its posture, and rotates the head unit about its rotation axis with the posture maintained at each of the image-capturing positions to rotate the rotating article in its circumferential direction.

3. The rotating article appearance inspection apparatus of claim 1, wherein the line sensor cameras are pre-focused on the image-capturing positions, and
the holding device moves the rotating article to the image-capturing positions where the line sensor cameras are in focus, and rotates the head unit about its rotation axis at the image-capturing positions to rotate the rotating article in a circumferential direction.

4. The rotating article appearance inspection apparatus of claim 1, wherein the plurality of image-capturing positions are arranged along one plane or one line, and
the holding device is a multi-joint robot having three or four axes, including one or two axes for moving the head unit on the plane or the line, one axis for moving the head unit in a direction intersecting the plane or the line, and one axis for rotating the head unit.

5. The rotating article appearance inspection apparatus of claim 1, wherein: the plurality of line sensor cameras are arranged such that their positions and orientations are set so that a portion in the radial direction of the rotating article, which rotates in its circumferential direction at each image-capturing position, around its entire circumference, is image-captured, and are configured such that the image-captured results of the plurality of the line sensor cameras include the entire area on one half toroidal portion of the rotating article;
the holding device aligns the central axis of the rotating article with the rotation axis of the head unit and, while maintaining the posture of the rotating article, sequentially moves the rotating article to the plurality of image-capturing positions respectively corresponding to the plurality of line sensor cameras of which the positions and orientations are maintained; and
by rotation of the head unit about its rotation axis at each imaging position, the rotating article, while rotating in its circumferential direction, is image-captured by the line sensor cameras.

6. The rotating article appearance inspection apparatus of claim 1, wherein the holding device is configured such that,
in at least part of the operations including a movement operation of the rotating article between the image-capturing positions and a rotation operation of the head unit, the head unit is oriented obliquely downward or downward.

7. The rotating article appearance inspection apparatus of claim 1, wherein: one or more illumination devices are provided for the plurality of line sensor cameras for emitting light toward the rotating article at the image-capturing positions; and
each of the illumination devices has one or more illumination units, and at least one of the illumination units is a first illumination unit configured to emit at least a part of light toward the rotating article at the image-capturing position along the orientation of the line sensor camera associated with the illumination device.

8. The rotating article appearance inspection apparatus of claim 7, wherein: one or more illumination devices provided corresponding to the plurality of line sensor cameras comprises
the first illumination unit that emits any one of green light, red light, and blue light, and
a second illumination unit that emits light of a color different from that of the first illumination unit; and
the first illumination unit is positioned at a greater distance from the image-capturing position than the second illumination unit.

9. The rotating article appearance inspection apparatus of claim 1, wherein the rotating article is an O-ring.

10. A rotating article appearance inspection method using a rotating article appearance inspection apparatus including line sensor cameras for image-capturing a rotating article having the shape of a rotating body and a holding device for holding the rotating article, wherein:
positions and orientations of a plurality of the line sensor cameras are preset; and
the rotating article is sequentially moved to a plurality of image-capturing positions respectively corresponding to the plurality of line sensor cameras.
